(19) United States
(12) Patent Application Publication
(10) Pub. No.: US 2026/0269284 A1
(43) Pub. Date: Sep. 10, 2026

(54) FUEL CELL SYSTEM

(71) Applicant: HONDA MOTOR CO., LTD., Tokyo (JP)

(72) Inventors: Yoshio OTANI, Saitama (JP); Yuji TERASAWA, Saitama (JP)

(21) Appl. No.: 19/541,664

(22) Filed: Feb. 17, 2026

(30) Foreign Application Priority Data
Mar. 6, 2025 (JP) 2025-035128

(51) Int. Cl. H01M 8/04089; H01M 8/04082; H01M 8/04119; H01M 8/04746

(52) U.S. Cl. CPC H01M 8/04104; H01M 8/04126; H01M 8/04201; H01M 8/04753; H01M 8/04761

(57) ABSTRACT

A fuel cell system includes: a fuel cell stack; a cathode gas supply flow path connected to the fuel cell stack; a cathode off-gas discharge flow path connected to the fuel cell stack; a bypass flow path connecting the cathode gas supply flow path and the cathode off-gas discharge flow path so as to bypass the fuel cell stack; a bypass valve provided in the bypass flow path and including a valve body configured to rotate to adjust a gas flow rate; and a first plate-shaped part for rectification provided in a part of the bypass flow path downstream of the valve body, wherein the first plate-shaped part for rectification includes a first proximal end adjacent to an outer edge of the valve body positioned at a predetermined rotation angle and extends along an extension direction of the bypass flow path.

### TECHNICAL FIELD

The present invention relates to a fuel cell system.

### BACKGROUND ART

In recent years, research and development are being conducted in relation to fuel cells which can contribute to energy efficiency to ensure that a greater number of people can access reliable, sustainable, and advanced energy at reasonable cost. One known fuel cell system includes, for the purpose of diluting the anode off-gas and the cathode off-gas discharged from the fuel cell stack, a bypass flow path connecting the cathode gas supply flow path and the cathode off-gas discharge flow path so as to bypass the fuel cell stack and a bypass valve for adjusting the flow rate of the gas flowing through the bypass flow path (for example, JP2006-32151A).

When the bypass valve is composed of a butterfly valve including a valve body configured to rotate to adjust the gas flow rate, a turbulence may occur on the downstream side of the valve body and this can be a cause for occurrence of noise. Particularly, when the gas flowing through the bypass valve is compressed air and the rotation angle of the valve body is small, a large pressure difference occurs between the upstream side and the downstream side of the valve body and a strong turbulence occurs on the downstream side of the valve body. Noise occurs due to this turbulence.

### SUMMARY OF THE INVENTION

In view of the foregoing background, an object of the present invention is to suppress occurrence of turbulence on the downstream side of the bypass valve, thereby providing measures to reduce noise and contributing to energy efficiency.

To achieve the above object, one aspect of the present invention provides a fuel cell system, comprising: a fuel cell stack; a cathode gas supply flow path connected to the fuel cell stack; a cathode off-gas discharge flow path connected to the fuel cell stack; a bypass flow path connecting the cathode gas supply flow path and the cathode off-gas discharge flow path so as to bypass the fuel cell stack; a bypass valve provided in the bypass flow path and including a valve body configured to rotate to adjust a gas flow rate; and a first plate-shaped part for rectification provided in a part of the bypass flow path downstream of the valve body, wherein the first plate-shaped part for rectification includes a first proximal end adjacent to an outer edge of the valve body positioned at a predetermined rotation angle and extends along an extension direction of the bypass flow path.

According to the above aspect, occurrence of turbulence on the downstream side of the valve body is suppressed and this provides measures to reduce noise.

### BRIEF DESCRIPTION OF THE DRAWINGS

FIG. 1 is a configuration diagram of a fuel cell system according to an embodiment;

FIG. 2 is a vertical sectional view of a main part of the fuel cell system according to the embodiment;

FIG. 3 is a half-sectional perspective view of the main part of the fuel cell system according to the embodiment;

FIG. 4 is a sectional view taken along line IV-IV in FIG. 2;

FIG. 5 is an explanatory diagram of a main part of a fuel cell system according to another embodiment; and

FIG. 6 is an explanatory diagram of a main part of a fuel cell system according to another embodiment.

### DETAILED DESCRIPTION OF THE INVENTION

In the following, an embodiment of a fuel cell system 10 according to the present invention will be described with reference to the drawings.

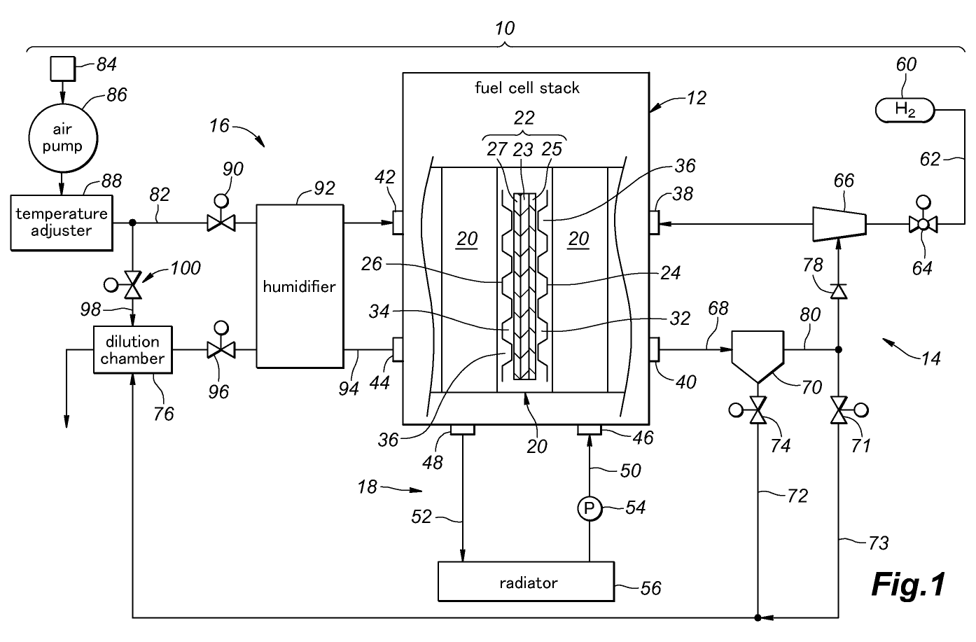

As shown in FIG. 1, the fuel cell system 10 includes a fuel cell stack 12, a fuel gas supply device 14 for supplying fuel gas (anode gas) to the fuel cell stack 12, an oxidizer gas supply device 16 for supplying oxidizer gas (cathode gas) to the fuel cell stack 12, and a cooling device 18 for cooling the fuel cell stack 12. In the present embodiment, the fuel gas is hydrogen gas, and the oxidizer gas is air.

The fuel cell stack 12 includes multiple power generation cells 20 which are stacked one on another. Each power generation cell 20 includes an electrolyte membrane-electrode structure 22 in a plate shape, a first separator 24 disposed on one side of the electrolyte membrane-electrode structure 22, and a second separator 26 disposed on the other side of the electrolyte membrane-electrode structure 22. The first separator 24 and the second separator 26 are preferably made of metal or carbon.

The electrolyte membrane-electrode structure 22 is composed of a laminate including a solid polymer electrolyte membrane 23 and an anode electrode 25 (fuel electrode) and a cathode electrode 27 (air electrode) sandwiching the solid polymer electrolyte membrane 23 from both sides. The solid polymer electrolyte membrane 23 may be a thin membrane of a fluorine-based electrolyte such as perfluorosulfonic acid containing moisture or may be a thin membrane of a hydrocarbon-based electrolyte.

In the fuel cell system 10, electric power is taken out from the anode electrode 25 and the cathode electrode 27.

Between the first separator 24 and the electrolyte membrane-electrode structure 22, an anode gas supply part 32 for supplying hydrogen gas, which serves as the anode gas, to the anode electrode 25 is formed. Between the second separator 26 and the electrolyte membrane-electrode structure 22, a cathode gas supply part 34 for supplying the cathode gas to the cathode electrode 27 is formed. Between the first separator 24 and the second separator 26 of each adjoining pair of power generation cells 20, a coolant flow path 36 through which coolant of the cooling device 18 circulates is formed.

The fuel cell stack 12 has an anode gas inlet 38, an anode off-gas outlet 40, a cathode gas inlet 42, a cathode off-gas outlet 44, a coolant inlet 46, and a coolant outlet 48. The anode gas inlet 38 is in communication with the gas intake side of the anode gas supply part 32 of each power generation cell 20. The anode off-gas outlet 40 is in communication with the gas discharge side of the anode gas supply part 32 of each power generation cell 20. The cathode gas inlet 42 is in communication with the gas intake side of the cathode gas supply part 34 of each power generation cell 20. The cathode off-gas outlet 44 is in communication with the discharge side of the cathode gas supply part 34 of each power generation cell 20. The coolant inlet 46 is in communication with the coolant intake side of the coolant flow path 36 of each power generation cell 20. The coolant outlet 48 is in communication with the coolant discharge side of the coolant flow path 36 of each power generation cell 20.

The cooling device 18 includes a coolant supply flow path 50 connected to the coolant inlet 46 of the fuel cell stack 12, a coolant discharge flow path 52 connected to the coolant outlet 48 of the fuel cell stack 12, a coolant circulation pump 54, and a radiator 56 connected to the coolant supply flow path 50 and the coolant discharge flow path 52. The coolant circulation pump 54 is provided on the coolant supply flow path 50 and causes the coolant to circulate. The coolant supply flow path 50, the coolant discharge flow path 52, the coolant circulation pump 54, and the radiator 56 constitute a coolant circulation flow path in cooperation with the coolant flow path 36 of each power generation cell 20. The coolant supply flow path 50 and the coolant discharge flow path 52 are preferably composed of resin tubes or rubber tubes to prevent elution of metal ions into the coolant and to maintain the insulating property of the coolant.

The fuel gas supply device 14 includes a hydrogen tank 60 storing high-pressure hydrogen gas. The hydrogen tank 60 is connected to the anode gas inlet 38 of the fuel cell stack 12 by an anode gas supply flow path 62 (fuel gas supply flow path). On the anode gas supply flow path 62, an injector 64 and an ejector 66 are provided in series with each other. The hydrogen gas, which is the anode gas, is supplied from the hydrogen tank 60 to the anode gas inlet 38 of the fuel cell stack 12 via the injector 64 and the ejector 66.

The anode off-gas outlet 40 is connected to a gas-liquid separation chamber 70 by an anode off-gas discharge flow path 68. The anode off-gas discharged from the anode off-gas outlet 40 is the hydrogen gas that has been at least partially used at the anode electrode 25 and contains moisture.

The gas-liquid separation chamber 70 has a gas-phase side and a liquid-phase side and separates the anode off-gas into gas and liquid. The liquid separated into the liquid-phase side of the gas-liquid separation chamber 70 is discharged to a drain flow path 72. The drain flow path 72 includes a drain valve 74 and is connected to a dilution chamber 76. The gas-phase side of the gas-liquid separation chamber 70 is connected to the ejector 66 by a gas flow path 80 including a one-way valve 78. With a negative internal pressure, the ejector 66 suctions the gas (hydrogen gas) from the gas-liquid separation chamber 70. The gas flow path 80 is connected to the drain flow path 72 by a purge flow path 73 including a purge valve 71. Thereby, when the purge valve 71 is opened, the anode off-gas after the gas-liquid separation is discharged to the dilution chamber 76.

The oxidizer gas supply device 16 includes a cathode gas supply flow path 82 (oxidizer gas supply flow path). One end of the cathode gas supply flow path 82 is provided with an air intake 84 for taking in air, which is the oxidizer gas, from the atmosphere. The other end of the cathode gas supply flow path 82 is connected to the cathode gas inlet 42 of the fuel cell stack 12. On the cathode gas supply flow path 82, an air pump 86, a temperature adjuster 88, a cathode gas flow control valve 90, and a humidifier 92 are provided in series in order from the side of the air intake 84. The air pump 86 is a compressor driven by a motor and compresses the air, which is the cathode gas, and outputs the compressed air. The temperature adjuster 88 includes a heater which may be of an electric heating wire type or a semiconductor type and adjusts the temperature of the compressed air outputted from the air pump 86. The compressed air outputted from the air pump 86 passes through the temperature adjuster 88, the cathode gas flow control valve 90, and the humidifier 92 and is supplied to the cathode gas inlet 42 of the fuel cell stack 12.

A cathode off-gas discharge flow path 94 is connected to the cathode off-gas outlet 44 of the fuel cell stack 12. The cathode off-gas in the cathode off-gas outlet 44 is the compressed air that has been at least partially used at the cathode electrode 27. On the cathode off-gas discharge flow path 94, the humidifier 92, an off-gas flow control valve 96, and the dilution chamber 76 are provided in order from the side of the cathode off-gas outlet 44. The cathode off-gas discharge flow path 94 discharges the cathode off-gas from the fuel cell stack 12 to the outside of the fuel cell stack 12 via the dilution chamber 76.

The humidifier 92 is of a membrane permeation type using a hollow fiber membrane and has a compressed air passage (not shown in the drawings) and a cathode off-gas discharge passage (not shown in the drawings) partitioned by the hollow fiber membrane. In the humidifier 92, moisture and heat are exchanged between the compressed air supplied from the air pump 86 and the cathode off-gas discharged from the fuel cell stack 12. The cathode off-gas discharged from the fuel cell stack 12 has a higher temperature and a higher humidity than the compressed air in the cathode gas supply flow path 82. Therefore, the temperature and the humidity of the compressed air supplied from the air pump 86 increase in the humidifier 92.

A part of the cathode gas supply flow path 82 between the temperature adjuster 88 and the humidifier 92 and a part of the cathode off-gas discharge flow path 94 downstream of the off-gas flow control valve 96 (in the present embodiment, the dilution chamber 76 is provided at this part of the cathode off-gas discharge flow path 94) are connected to each other by a bypass flow path 98. Thereby, the bypass flow path 98 connects the cathode gas supply flow path 82 and the cathode off-gas discharge flow path 94 so as to bypass the fuel cell stack 12. A bypass valve 100 is provided in the bypass flow path 98.

In the dilution chamber 76, the anode off-gas discharged from the drain flow path 72 is diluted by the cathode off-gas from the cathode off-gas discharge flow path 94 or the compressed air from the bypass flow path 98.

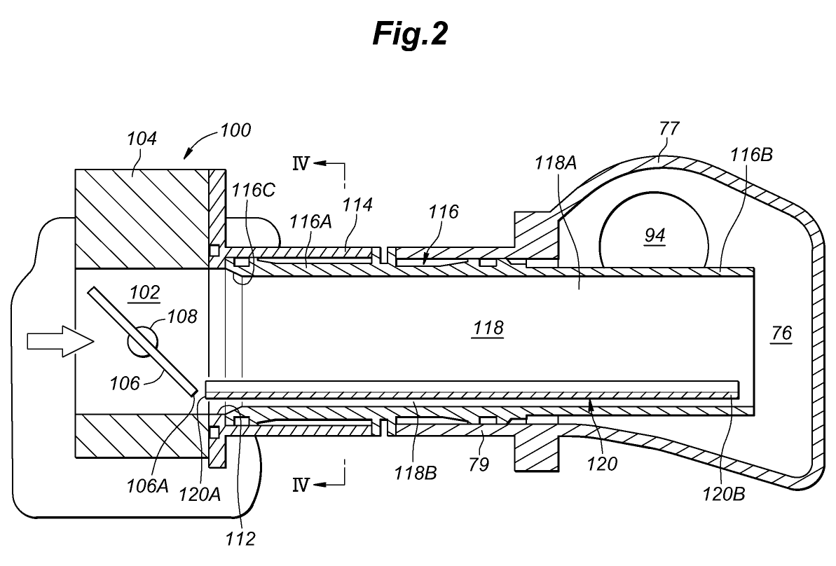

Details of the dilution chamber 76, the bypass flow path 98, and the bypass valve 100 will now be described with reference to FIGS. 2-4.

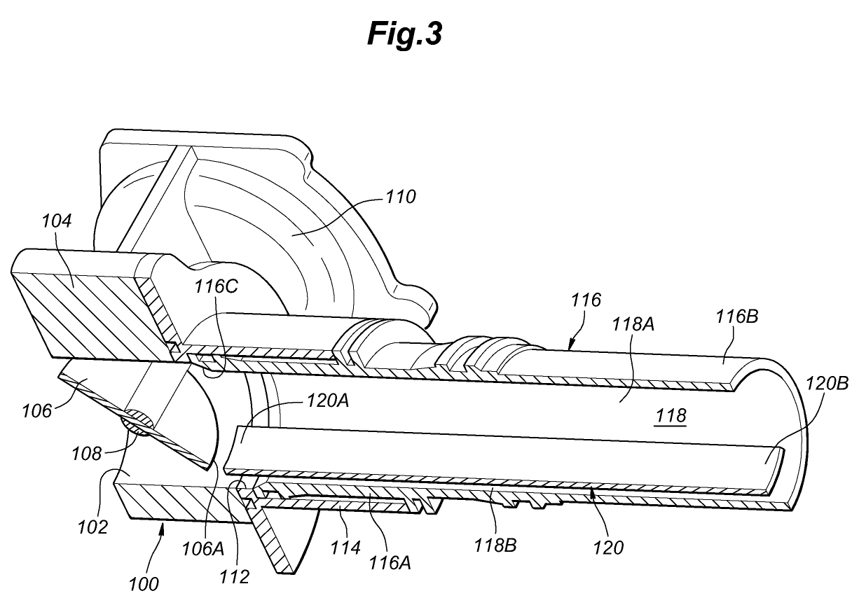

The bypass valve 100 includes a valve housing 104 provided with a valve chamber 102 which is cylindrical in shape, namely, has a circular cross section. The valve chamber 102 constitutes a part of the bypass flow path 98 and the compressed air flows in the valve chamber 102 from left to right in FIGS. 2 and 3. The valve chamber 102 houses a disc-shaped valve body 106. The valve housing 104 pivotably supports the valve body 106 via a shaft 108. Thereby, the bypass valve 100 constitutes a butterfly valve for quantitatively adjusting the gas flow rate (the compressed air flow rate) in the bypass flow path 98 by rotation of the valve body 106. An electric motor 110 (see FIG. 3) for rotatably driving the valve body 106 via the shaft 108 is mounted on the valve housing 104.

On the right wall surface of the valve housing 104, an outlet port member 114 which has a cylindrical with a flange and defines an outlet port 112 communicating with the valve chamber 102 is mounted. The inner diameter of the outlet port 112 may be substantially the same as the inner diameter of the valve chamber 102.

In the outlet port 112, one end portion 116A of cylindrical joint pipe 116 is inserted. The other end portion 116B of the joint pipe 116 is inserted in an inlet port 79 of a dilution chamber housing 77 defining the dilution chamber 76 and protrudes into the dilution chamber 76. The joint pipe 116 has a pipe flow path 118 which connects the valve chamber 102 and the dilution chamber 76 and constitutes a part of the bypass flow path 98. In other words, the pipe flow path 118 constitutes a part of the bypass flow path 98 downstream of the valve chamber 102.

The inner diameter of the pipe flow path 118 is smaller than the inner diameter of the valve chamber 102 and the outlet port 112. The pipe flow path 118 includes an insertion-side end portion 116C which is adjacent to the valve chamber 102 and the outlet port 112 and is configured such that the inner diameter thereof is gradually increased toward the outlet port 112 until it becomes the same as the inner diameter of the valve chamber 102 and the outlet port 112. Thereby, the pipe flow path 118 is smoothly connected to the valve chamber 102 and the outlet port 112 without a step formed at the connection.

A first rectifier plate 120 (first plate-shaped part for rectification) is provided on the downstream side of the valve body 106. The first rectifier plate 120 is disposed in the joint pipe 116, namely, the pipe flow path 118, and is fixed to the joint pipe 116.

The first rectifier plate 120 is provided on a side where the outer edge 106A of the valve body 106 is displaced toward the downstream side of the pipe flow path 118 when the valve body 106 is opened from the fully closed position. The first rectifier plate 120 includes a first proximal end 120A adjacent to the outer edge 106A of the valve body 106 positioned at a relatively small predetermined rotation angle and extends along the extension direction of the pipe flow path 118 to the vicinity of the other end portion 116B of the joint pipe 116. The pipe flow path 118 is divided into a primary flow path 118A and a secondary flow path 118B by the first rectifier plate 120 when the valve body 106 is positioned at the aforementioned predetermined rotation angle.

The bypass valve 100 is fully closed during a full load operation of the fuel cell stack 12 in which the cathode gas flow control valve 90 is fully opened, and is partially opened with the valve body 106 positioned at the aforementioned predetermined rotation angle during most operations other than the full load operation (namely, during most partial load operations).

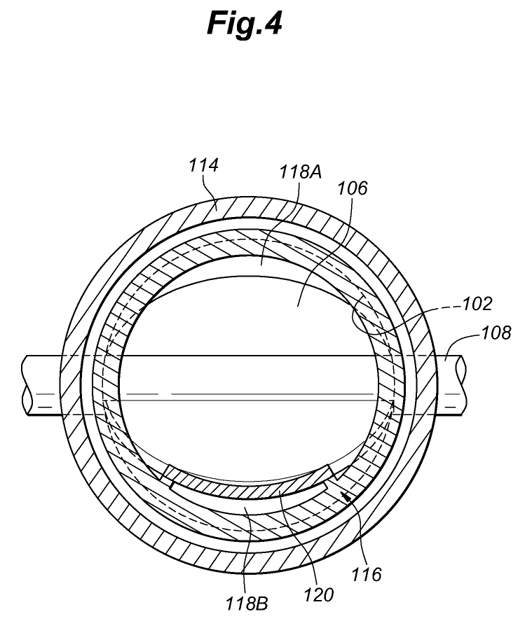

The first proximal end 120A of the first rectifier plate 120 has a cross section in a shape curved along the outer edge 106A of the valve body 106 when the valve body 106 is positioned at the aforementioned predetermined rotation angle (see FIG. 4). The first proximal end 120A may include a part entering the valve chamber 102. The curved cross-sectional shape of the first rectifier plate 120 may be uniform from the first proximal end 120A to a first distal end 120B on the side of the other end portion 116B of the joint pipe 116.

As mentioned above, the first rectifier plate 120 is provided on the side where the outer edge 106A of the valve body 106 is displaced toward the downstream side of the pipe flow path 118 when the valve body 106 is opened from the fully closed position. In other words, the first rectifier plate 120 is disposed in a part where turbulence is likely to occur. Thereby, occurrence of turbulence is effectively suppressed by the first rectifier plate 120.

In the present embodiment, as shown in FIGS. 2 and 3, when the rotation angle of the valve body 106 is the relatively small predetermined rotation angle, the first proximal end 120A of the first rectifier plate 120 is adjacent to the outer edge 106A of the valve body 106. Therefore, when the valve body 106 is positioned at the predetermined rotation angle, the pipe flow path 118 downstream of the valve body 106 is clearly divided into the primary flow path 118A and the secondary flow path 118B, and the compressed air flows in the primary flow path 118A and the secondary flow path 118B in a divided manner. In other words, under good rectifying action in each flow path, the movement of the compressed air that may lead to a strong turbulence particularly in the secondary flow path 118B is blocked by the first rectifier plate 120. Thereby, occurrence of turbulence in the pipe flow path 118 is effectively suppressed, and occurrence of noise from the joint pipe 116 is effectively suppressed.

Since the first rectifier plate 120 has a cross section in a shape curved along the outer edge 106A of the valve body 106, the compressed air flows smoothly from the valve chamber 102 to the primary flow path 118A and the secondary flow path 118B. Thus, occurrence of noise is suppressed more effectively.

Further, since the pipe flow path 118 is smoothly connected to the valve chamber 102 and the outlet port 112 without a step, occurrence of disturbance in the compressed air flowing from the valve chamber 102 and the outlet port 112 to the pipe flow path 118 is suppressed. Thereby, occurrence of noise and vibration due to disturbance (turbulence) in the air flow in the pipe flow path 118 is suppressed.

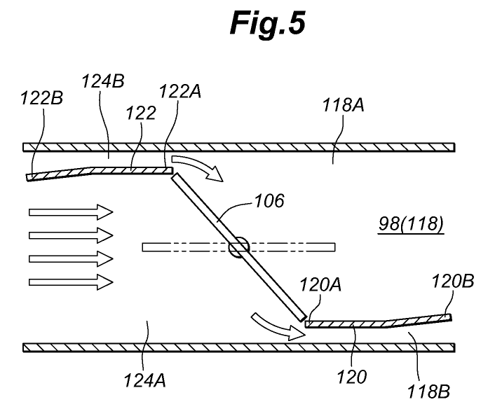

FIG. 5 schematically shows a main part of another embodiment of the fuel cell system 10. Note that in FIG. 5, parts corresponding to those shown in FIGS. 1-4 are denoted by the same reference signs as in FIGS. 1-4 and the description thereof will be omitted.

In this embodiment, in addition to the first rectifier plate 120, a second rectifier plate 122 (second plate-shaped part for rectification) is provided on the upstream side of the valve body 106 provided in the bypass flow path 98. The second rectifier plate 122 includes a second proximal end 122A adjacent to the outer edge 106A of the valve body 106 positioned at the aforementioned predetermined rotation angle and extends in the extension direction of the bypass flow path 98.

A part of the bypass flow path 98 upstream of the valve body 106 is divided into a primary flow path 124A and a secondary flow path 124B by the second rectifier plate 122.

A part of the first rectifier plate 120 on the side of the first distal end 120B is formed such that the cross-sectional area of the secondary flow path 118B gradually increases toward the downstream side. A part of the second rectifier plate 122 on the side of the second distal end 122B is formed such that the cross-sectional area of the secondary flow path 124B gradually increases toward the upstream side.

In this embodiment, due to the provision of the second rectifier plate 122, disturbance of the air flow in the part of the bypass flow path 98 upstream of the valve body 106 is suppressed.

Further, the part of the first rectifier plate 120 on the side of the first distal end 120B is formed such that the cross-sectional area of the secondary flow path 118B gradually increases toward the downstream side and the part of the second rectifier plate 122 on the side of the second distal end 122B is formed such that the cross-sectional area of the secondary flow path 124B gradually increases toward the upstream side. Due to these, effective rectifying action is obtained and occurrence of turbulence in the bypass flow path 98 is effectively suppressed.

In the foregoing, the present invention has been described in terms of preferred embodiments thereof. However, as will be readily appreciated by a person of ordinary skill in the art, the present invention is not limited to such embodiments and may be modified appropriately within spirit of the present invention.

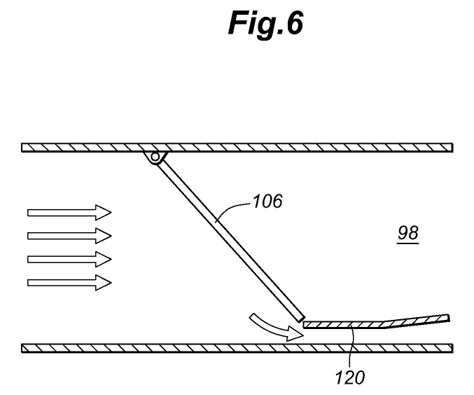

For example, the cross-sectional shape of the first rectifier plate 120 may be curved, at the first proximal end 120A, along the outer edge 106A of the valve body 106 positioned at the predetermined rotation angle, and may gradually approach a linear shape toward the first distal end 120B. The first rectifier plate 120 may be composed of multiple plate members arranged in parallel with each other to correspond to the valve body 106 at different rotation angles. The valve body 106 may be composed of a flapper valve as shown in FIG. 6.

The above embodiment may be described as follows.

One embodiment is a fuel cell system 10, comprising: a fuel cell stack 12; a cathode gas supply flow path 82 connected to the fuel cell stack 12; a cathode off-gas discharge flow path 94 connected to the fuel cell stack 12; a bypass flow path 98 connecting the cathode gas supply flow path 82 and the cathode off-gas discharge flow path 94 so as to bypass the fuel cell stack 12; a bypass valve 100 provided in the bypass flow path 98 and including a valve body 106 configured to rotate to adjust a gas flow rate; and a first rectifier plate 120 (first plate-shaped part for rectification) provided in a part of the bypass flow path 98 downstream of the valve body 106, wherein the first rectifier plate 120 includes a first proximal end 120A adjacent to an outer edge 106A of the valve body 106 positioned at a predetermined rotation angle and extends along an extension direction of the bypass flow path 98.

According to this configuration, occurrence of turbulence on the downstream side of the valve body 106 is suppressed by the first rectifier plate 120.

In the above aspect, the bypass valve 100 may be composed of a butterfly valve and the valve body 106 may have a disc shape, and the first rectifier plate 120 may be provided on a side where an outer edge 106A of the valve body 106 is displaced toward a downstream of the bypass flow path 98 when the valve body 106 is opened from a fully closed position.

According to this configuration, the first rectifier plate 120 is provided in a part where turbulence is likely to occur, and occurrence of turbulence is suppressed effectively.

In the above aspect, the bypass flow path 98 may be divided into a primary flow path 118A and a secondary flow path 118B by the first rectifier plate 120 when the valve body 106 is positioned at the predetermined rotation angle.

According to this configuration, under good rectifying action, occurrence of turbulence on the downstream side of the valve body 106 is effectively suppressed.

In the above aspect, the first rectifier plate 120 may have a cross section in a shape curved along the outer edge 106A of the valve body 106.

According to this configuration, under good rectifying action, occurrence of turbulence on the downstream side of the valve body 106 is effectively suppressed.

In the above aspect, the bypass valve 100 may comprise a valve housing 104 including a cylindrical valve chamber 102 that pivotably supports a valve body 106 via a shaft 108 and houses the valve body 106, and an outlet port member 114 that is mounted on the valve housing 104 and defines an outlet port 112 communicating with the valve chamber 102, a cylindrical joint pipe 116 defining a part of the bypass flow path 98 may be inserted in the outlet port 112, and the first rectifier plate 120 may be disposed in the joint pipe 116.

According to this configuration, occurrence of turbulence in the joint pipe 116 is effectively suppressed.

In the above aspect, the joint pipe 116 may include an insertion-side end portion 116C adjacent to the valve chamber 102 such that the bypass flow path 98 is smoothly connected to the valve chamber 102 without a step between the bypass flow path 98 and the valve chamber 102.

According to this configuration, occurrence of turbulence at the connection between the valve chamber 102 and the bypass flow path 98 is suppressed.

In the above aspect, the fuel cell system may further comprise a second rectifier plate 122 (second plate-shaped part for rectification) provided in a part of the bypass flow path 98 upstream of the valve body 106, wherein the second rectifier plate 122 includes a second proximal end 122A adjacent to the outer edge 106A of the valve body 106 positioned at the predetermined rotation angle and extends along the extension direction of the bypass flow path 98.

According to this configuration, occurrence of turbulence on the upstream side of the valve body 106 is suppressed.

Not all of the components shown in the foregoing embodiments are necessarily indispensable and they may be selectively adopted as appropriate within the spirit of the present invention.

1. A fuel cell system, comprising:
a fuel cell stack;
a cathode gas supply flow path connected to the fuel cell stack;
a cathode off-gas discharge flow path connected to the fuel cell stack;
a bypass flow path connecting the cathode gas supply flow path and the cathode off-gas discharge flow path so as to bypass the fuel cell stack;
a bypass valve provided in the bypass flow path and including a valve body configured to rotate to adjust a gas flow rate; and
a first plate-shaped part for rectification provided in a part of the bypass flow path downstream of the valve body, wherein the first plate-shaped part for rectification includes a first proximal end adjacent to an outer edge of the valve body positioned at a predetermined rotation angle and extends along an extension direction of the bypass flow path.

2. The fuel cell system according to claim 1, wherein the bypass valve is composed of a butterfly valve and the valve body has a disc shape, and
the first plate-shaped part for rectification is provided on a side where the outer edge of the valve body is displaced toward a downstream side of the bypass flow path when the valve body is opened from a fully closed position.

3. The fuel cell system according to claim 2, wherein the bypass flow path is divided into a primary flow path and a secondary flow path by the first plate-shaped part for rectification when the valve body is positioned at the predetermined rotation angle.

4. The fuel cell system according to claim 2, wherein the first plate-shaped part for rectification has a cross section in a shape curved along the outer edge of the valve body.

5. The fuel cell system according to claim 2, wherein the bypass valve comprises a valve housing including a cylindrical valve chamber that pivotably supports a valve body via a shaft and houses the valve body, and an outlet port member that is mounted on the valve housing and defines an outlet port communicating with the valve chamber,
a cylindrical joint pipe defining a part of the bypass flow path is inserted in the outlet port, and
the first plate-shaped part for rectification is disposed in the joint pipe.

6. The fuel cell system according to claim 5, wherein the joint pipe includes an insertion-side end portion adjacent to the valve chamber such that the bypass flow path is smoothly connected to the valve chamber without a step between the bypass flow path and the valve chamber.

7. The fuel cell system according to claim 1, further comprising a second plate-shaped part for rectification provided in a part of the bypass flow path upstream of the valve body, wherein the second plate-shaped part for rectification includes a second proximal end adjacent to the outer edge of the valve body positioned at the predetermined rotation angle and extends along the extension direction of the bypass flow path.
